(19) United States
(12) Patent Application Publication
(10) Pub. No.: US 2025/0296051 A1
(43) Pub. Date: Sep. 25, 2025

(54) GAS SEPARATION MEMBRANE, AND METHOD OF MANUFACTURING GAS SEPARATION MEMBRANE

(71) Applicant: HONDA MOTOR CO., LTD., Tokyo (JP)

(72) Inventor: Yoshinori Tsurugai, Wako-shi (JP)

(21) Appl. No.: 19/059,373

(22) Filed: Feb. 21, 2025

(30) Foreign Application Priority Data
Mar. 21, 2024 (JP) 2024-044764

(51) Int. Cl. B01D 67/00; B01D 69/10; B01D 69/12; B01D 71/76

(52) U.S. Cl. CPC B01D 67/002; B01D 69/106; B01D 69/12; B01D 71/76

(57) ABSTRACT

A gas separation membrane includes a porous substrate, a first gas separating layer impregnated and formed onto one surface of the porous substrate, and a second gas separating layer disposed so as to overlap the first gas separating layer, the first gas separating layer having higher gas permeability and lower gas selectivity than the second gas separating layer.

### CROSS-REFERENCE TO RELATED APPLICATION

Priority is claimed on Japanese Patent Application No. 2024-044764, filed Mar. 21, 2024, the content of which is incorporated herein by reference.

### BACKGROUND OF THE INVENTION

### Field of the Invention

The present invention relates to a gas separation membrane, and a method of manufacturing a gas separation membrane, which are capable of separating an arbitrary gas from multiple types of mixed gas.

### Description of Related Art

A gas separation membrane that separates an arbitrary gas from multiple types of mixed gas is, for example, a functional membrane that can selectively separate only carbon dioxide from a combustion gas with a high concentration of carbon dioxide exhausted from a plant or the like, or selectively separate only nitrogen oxides contained in an exhaust gas from an automobile.

Such a gas separation membrane is constituted by a polymer material or the like that selectively allows only specific gases to pass through in general (for example, see Japanese Unexamined Patent Application, First Publication No. 2018-167149). In the gas separation membrane in the related art, in order to ensure sufficient gas separability, it was necessary to increase a thickness of the membrane. However, increasing the thickness of the gas separation membrane reduces the gas permeability, so in order to maintain a separation rate, it was necessary to supply the gas at a high pressure. When a supply pressure of a gas to the gas separation membrane is high, the gas separation membrane becomes more susceptible to damage.

For this reason, for example, Japanese Unexamined Patent Application, First Publication No. 2022-045753 discloses a gas separation membrane that has improved permeability and separability for a gas by providing a configuration in which clusters of a plurality of particles aggregated within pores of a porous substrate are placed in contact with a gas separating layer.

### SUMMARY OF THE INVENTION

However, even in the gas separation membrane disclosed in Japanese Unexamined Patent Application, First Publication No. 2022-045753, unless the separating layer formed on the porous substrate has a sufficient membrane thickness, good gas separation cannot be achieved. For this reason, even when the particle clusters are formed in the pores of the porous substrate, sufficient gas permeability cannot be secured.

An aspect of the present invention is directed to providing a highly functional gas separation membrane, and a method of manufacturing a highly functional gas separation membrane, which are capable of increasing separability of a gas and increasing permeability to the gas.

The inventors discovered that by configuring a gas separation membrane from two layers, with one layer thereof being impregnated into the surface of a porous substrate, it is possible to achieve both high permeability and separability of the gas separation membrane.
(1) A gas separation membrane of aspect 1 of the present invention includes a porous substrate; a first gas separating layer impregnated and formed onto one surface of the porous substrate; and a second gas separating layer disposed so as to overlap the first gas separating layer, and the first gas separating layer has higher gas permeability and lower gas selectivity than the second gas separating layer.
(2) According to aspect 2 of the present invention, in the gas separation membrane of aspect 1, an average pore diameter of the first gas separating layer is smaller than an average pore diameter of the porous substrate, and equal to or smaller than a thickness of the second gas separating layer.
(3) Aspect 3 of the present invention is a method of manufacturing a gas separation membrane for manufacturing the gas separation membrane according to aspect 1 or 2, the method including: a first membrane forming liquid application process of applying a first membrane forming liquid in which composition materials of the first gas separating layer are dissolved or distributed in a first solvent onto one surface side of the porous substrate, impregnating the first membrane forming liquid to a predetermined depth from the one surface of the porous substrate, and forming the first gas separating layer impregnated onto the one surface of the porous substrate; and a second membrane forming liquid application process of applying a second membrane forming liquid in which composition materials of the second gas separating layer are dissolved or distributed in a second solvent so as to overlap the first gas separating layer impregnated onto the one surface side of the porous substrate by the first membrane forming liquid application process and forming the second gas separating layer.
(4) According to aspect 4 of the present invention, in the method of manufacturing a gas separation membrane of aspect 3, the first solvent is poorly soluble or insoluble in the second solvent.
(5) According to aspect 5 of the present invention, in the method of manufacturing a gas separation membrane of aspect 3 or 4, the first solvent is a non-polar solvent and the second solvent is a polar solvent.
(6) According to aspect 6 of the present invention, in the method of manufacturing a gas separation membrane of any one of aspects 3 to 5, the composition materials of the first gas separating layer are rubber-like polymer materials, and the composition materials of the second gas separating layer are glass-like polymer materials.
(7) According to aspect 7 of the present invention, in the method of manufacturing a gas separation membrane of any one of aspects 3 to 6, application of the first membrane forming liquid application process and the second membrane forming liquid application process is spray application.

According to the aspect of the present invention, it is possible to provide a highly functional gas separation membrane, and a method of manufacturing a highly functional gas separation membrane, which are capable of increasing separability of a gas and increasing permeability of the gas.

### BRIEF DESCRIPTION OF THE DRAWINGS

FIG. 1 is a schematic cross-sectional view showing an example of a gas separation membrane of an embodiment.

FIG. 2 is a flowchart showing a method of manufacturing a gas separation membrane of an embodiment of the present invention.

### DETAILED DESCRIPTION OF THE INVENTION

Hereinafter, a gas separation membrane, and a method of manufacturing a gas separation membrane of an embodiment of the present invention will be described with reference to the accompanying drawings. Further, the embodiment shown below is specifically described to provide a better understanding of the scope of the invention, and unless otherwise specified, the present invention is not limited. In addition, the drawings used in the following description may, for convenience, show enlarged key parts in order to make the features of the present invention easier to understand, and dimensional proportions of each component may not necessarily be the same as the actual ones.

### Gas Separation Membrane

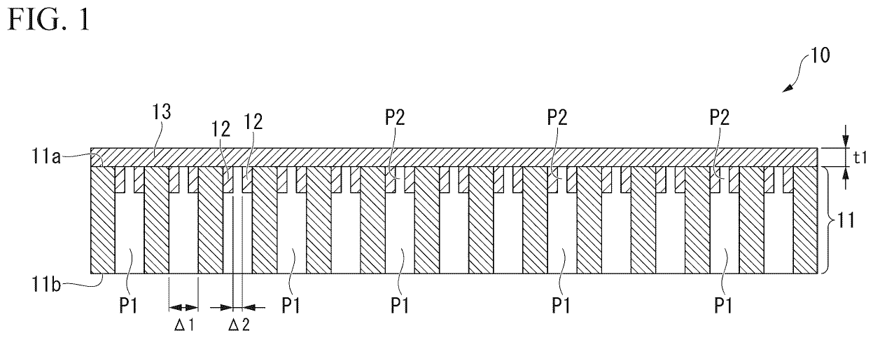

FIG. 1 is a schematic cross-sectional view showing a gas separation membrane of an embodiment of the present invention.

A gas separation membrane 10 of the embodiment is, for example, a functional membrane selectively allowing only carbon dioxide to pass through from a mixed gas in which carbon dioxide, nitrogen, and oxygen are mixed, and separating the mixed gas into carbon dioxide, nitrogen and oxygen.

The gas separation membrane 10 of the embodiment is constituted by a substrate 11, a first gas separating layer 12, and a second gas separating layer 13.

The substrate 11 is a support body formed of a porous material and configured to support the first gas separating layer 12 or the second gas separating layer 13. The substrate 11 has a plurality of pores P1 formed to pass through between one surface 11a and the other surface 11b.

As composition materials of the substrate 11, for example, porous polyethylene (PE), porous polypropylene (PP), porous polyethylene terephthalate (PET), porous polytetrafluoroethylene (PTFE), and the like, are exemplified.

A shape of the substrate 11 may be, for example, a sheet shape. A thickness of the substrate 11 may be a thickness that is not damaged by an inflow pressure of a gas in a separation target, and for example, may be 10 μm or more and 100 μm or less. In addition, as a specific example of a size Δ1 of the pores P1 formed in the substrate 11, for example, an average pore diameter may be within a range of 10 μm or more and 100 μm or less.

The first gas separating layer 12 is a layer impregnated in an arbitrary range from the one surface 11a of the substrate 11 in a thickness direction T, and the one surface (upper surface) is located at the same position as the one surface 11a of the substrate 11. That is, the first gas separating layer 12 is formed in such a manner that its entirety is impregnated into the one surface 11a of the substrate 11. More specifically, the composition materials of the first gas separating layer 12 are formed on the side of the one surface 11a of the substrate 11 so as to penetrate into some of the plurality of pores P1 present in the substrate 11.

As the composition materials of the first gas separating layer 12, rubber-like polymer materials having a plurality of pores such as porous silicon resin, porous polydimethylsiloxane (PDMS), polyethylene imine (PEI), and the like, can be exemplified.

The first gas separating layer 12 may be formed by impregnating from the one surface 11a of the substrate 11 in the thickness direction T, for example, in the range of 1 μm or more and 10 μm or less. It is preferable that the first gas separating layer 12 is formed so that the upper surface is not laminated above the one surface 11a of the substrate 11.

An average pore diameter of a plurality of pores P2 formed in the first gas separating layer 12 is formed to be smaller than the average pore diameter of the plurality of pores P1 of the substrate 11. That is, since the plurality of pores P1 of the substrate 11 has an average pore diameter reduced on the side of the one surface 11a because the first gas separating layer 12 is impregnated and formed therein, this becomes the plurality of pores P2 formed in the first gas separating layer 12.

In addition, the average pore diameter of the plurality of pores P2 formed in the first gas separating layer 12 is equal to or smaller than a membrane thickness Δt of the second gas separating layer 13 which is formed over it. As a specific example of a size Δ2 of the pores P2 formed in the first gas separating layer 12, the average pore diameter may be, for example, 1 μm or less.

The second gas separating layer 13 is a layer formed to overlap a forming region of the first gas separating layer 12 on the one surface 11a of the substrate 11. As the composition materials of the second gas separating layer 13, glass-like polymer materials such as polyimide (PI), polysulfone (PSU), polyamide (PA), and the like, can be exemplified.

The second gas separating layer 13 may be laminated within a range of, for example, 1 μm or more and 10 μm or less from the one surface 11a of the substrate 11. In addition, the second gas separating layer 13 is laminated such that the membrane thickness Δt of the second gas separating layer 13 is greater than an average pore diameter Δ2 of the plurality of pores P2 formed in the first gas separating layer 12 there under.

According to the gas separation membrane 10 of the embodiment having the above-mentioned configuration, in the first gas separating layer 12 and the second gas separating layer 13 having the gas separating function, by impregnating the first gas separating layer 12 within the thickness range of the substrate 11, the pores P1 of the substrate 11 are narrowed and the pores P2 of the first gas separating layer 12 are formed on the side of the one surface 11a of the substrate 11.

Accordingly, the thickness of the first gas separating layer 12 falls within the thickness range of the substrate 11, the membrane thickness is reduced to provide excellent gas permeability, and the membrane has a two-layer gas separating function constituted by the first gas separating layer 12 and the second gas separating layer 13, achieving high gas separation. Accordingly, according to the embodiment, it is possible to realize the gas separation membrane 10 that is capable of achieving both gas permeability and gas separability.

In addition, since the pores P1 of the substrate 11 can be narrowed to an arbitrary average pore diameter on the side of the one surface 11a by an impregnating material and impregnating time of the first gas separating layer 12, sufficient gas separability can be achieved without using an expensive material with a particularly small variation in the average pore diameter for the substrate 11. Accordingly, the gas separation membrane 10 can be realized at low cost by using an inexpensive substrate.

Further, in the embodiment, while one type of substrate 11 is used, multiple layers of substrates having different average pore diameter can also be used. In addition, it is also possible to form a further gas separating layer on top of the second gas separating layer 13, thereby forming a membrane having a gas separating function from three or more functional membrane layers.

### Method of Manufacturing Gas Separation Membrane

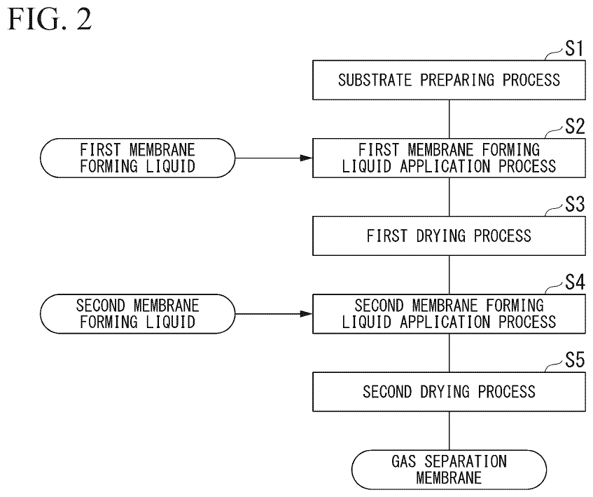

FIG. 2 is a flowchart showing a method of manufacturing a gas separation membrane of an embodiment of the present invention. In the embodiment, a method of manufacturing the gas separation membrane 10 of the above-mentioned embodiment will be described.

The method of manufacturing a gas separation membrane of the embodiment includes a substrate preparing process S1, a first membrane forming liquid application process S2, a first drying process S3, a second membrane forming liquid application process S4, and a second drying process S5.

First, the substrate 11 that is a support body configured to support the first gas separating layer 12 and the second gas separating layer 13, which are formed in a post-process, is prepared (the substrate preparing process S1). In the embodiment, as the substrate 11, a sheet material formed of porous polyethylene (PE) is used.

Next, a first membrane forming liquid in which the composition materials of the first gas separating layer 12 are dissolved or dispersed toward the one surface 11a of the substrate 11 in a first solvent is applied to the one surface 11a of the substrate 11 (the first membrane forming liquid application process S2).

In this embodiment, rubber-like polymer materials, such as silicon resin, dispersed in a first solvent were used as the first membrane forming liquid. As the first solvent, a poorly soluble or insoluble solvent is used as a second solvent to form the second gas separating layer 13 described below. As a specific example of the first solvent, various liquid oils, benzene, hexane, toluene, and the like, which are non-polar solvents, are exemplified. In the embodiment, benzene was used as the first solvent. That is, in the embodiment, as the first membrane forming liquid, silicon resin dissolved in benzene was used.

The first membrane forming liquid may be applied to the one surface 11a of the substrate 11 by spray application or application using a roll coater. In the embodiment, the first membrane forming liquid was sprayed onto the one surface 11a of the substrate 11 using a spray device. By using the spray application, droplets during application become smaller, which has an effect of shortening the drying time in the next first drying process S3.

In the first membrane forming liquid application process S2, by applying the first membrane forming liquid onto the one surface 11a of the substrate 11, the first membrane forming liquid is impregnated to a predetermined depth in the thickness direction T from the one surface 11a of the substrate 11. The first membrane forming liquid is impregnated so as to penetrate into some of the plurality of pores P1 present in the substrate 11.

Then, the solvent contained in the first membrane forming liquid impregnated to the predetermined depth from the side of the one surface 11a of the substrate 11, i.e., benzene in the embodiment, is evaporated by the next first drying process S3, and the first gas separating layer 12 formed of silicon resin is impregnated and formed to the predetermined depth from the side of the one surface 11a of the substrate 11. This first drying process (S3) can be performed using various drying methods, such as air drying, blow drying, or drying with an infrared heater, within a temperature range in which the substrate 11 or the silicon resin is not softened.

In the first drying process S3, since the benzene contained in the impregnated first membrane forming liquid is evaporated, the silicon resin become porous, and the plurality of pores P2 are formed. These pores P2 are formed by reducing the pore width of the pores P1, which have a larger pore diameter in the substrate 11, through impregnation.

In this way, the first gas separating layer 12 impregnated into the substrate 11 has an upper surface which is flush with the one surface 11a of the substrate 11, and the entire layer is formed inside the one surface 11a side of the substrate 11. Accordingly, the total thickness of the substrate 11 and the first gas separating layer 12 is the same as the thickness of the substrate 11, and the formation of the first gas separating layer 12 does not increase the thickness of the substrate 11. Accordingly, a part of the gas separating function is applied to the one surface 11a side of the substrate 11.

Further, while a solution in which silicon resin is dissolved in benzene is used as the first membrane forming liquid in the embodiment, there is no limitation thereto, and for example, a solution in which polydimethylsiloxane (PDMS) is dissolved in toluene can be used as the first membrane forming liquid. In this way, even in the first membrane forming liquid in which the resin is dissolved in the solvent, the resin can become porous and the pores P2 can be formed by evaporating the solvent in the first drying process S3.

Next, a second membrane forming liquid obtained by dissolving or distributing composition materials of the second gas separating layer 13 in a second solvent toward a region in which the first gas separating layer 12 is formed in the one surface 11a of the substrate 11 is applied to the upper surface of the first gas separating layer 12 (the second membrane forming liquid application process S4).

In the embodiment, as the second membrane forming liquid, glass-like polymer materials, such as polysulfone (PSU), dispersed in a second solvent were used. As the second solvent, a solvent that is poorly soluble or insoluble in the first solvent is used to form the first gas separating layer 12 described above. As a specific example of the second solvent, water or ethanol, which is a polar solvent, is exemplified. In the embodiment, ethanol was used as the second solvent. That is, in the embodiment, as the second membrane forming liquid, a solution in which polysulfone is distributed in ethanol was used.

A method of applying the second membrane forming liquid to an upper surface of the first gas separating layer 12 may be performed by spray application or application by a roll coater. In the embodiment, the second membrane forming liquid was sprayed onto the upper surface of the first gas separating layer 12 using a spray device.

In the second membrane forming liquid application process S4, a thin film of the second membrane forming liquid is formed to overlap the upper surface of the first gas separating layer 12 by applying the second membrane forming liquid on the upper surface of the first gas separating layer 12. Here, since the solvent that constitutes the second membrane forming liquid is poorly soluble or insoluble in the solvent that constitutes the first membrane forming liquid, the second membrane forming liquid is not impregnated into the first gas separating layer 12, and the second membrane forming liquid is formed on the first gas separating layer 12 with a predetermined thickness.

Then, in the next second drying process S5, the solvent contained in the second membrane forming liquid formed to overlap the upper surface of the first gas separating layer 12, i.e., ethanol in this embodiment, evaporates, and the second gas separating layer 13 made of polysulfone with a predetermined thickness is laminated to overlap the upper surface of the first gas separating layer 12. Like the first drying process S3, the second drying process S5 can also use various drying methods, such as air drying, blow drying, and drying with an infrared heater, within a temperature range in which the substrate 11, the silicon resin, and the polysulfone are not softened.

In this way, the membrane thickness Δt of the second gas separating layer 13 laminated to overlap the first gas separating layer 12 is set to be greater than the average pore diameter Δ2 of the pores P2 of the first gas separating layer 12 there under.

Through the above steps, the gas separation membrane 10 of this embodiment can be obtained, in which two layers of functional membranes having a gas separating function, i.e., the first gas separating layer 12 and the second gas separating layer 13, are supported by the substrate 11.

According to the gas separation membrane 10 obtained in this way, for example, when air containing a high concentration of carbon dioxide is supplied to one surface of the gas separation membrane 10 at a predetermined pressure, the first gas separating layer 12 and the second gas separating layer 13 selectively allow only the carbon dioxide to pass through while blocking the other air components such as nitrogen or oxygen. This gas separating function makes it possible to remove only carbon dioxide from combustion gases that contain a high concentration of carbon dioxide.

Further, the gas separation membrane 10 is not limited to selective permeation of carbon dioxide, but can also selectively permeate, for example, only nitrogen oxide from automobile exhaust gas, or various harmful gases, depending on the composition materials and the pore diameter of the first gas separating layer 12 or the second gas separating layer 13, and does not limit the gas components of the separation target.

According to the method of manufacturing a gas separation membrane of the embodiment described above, the first gas separating layer 12 is impregnated and formed into the substrate 11, thereby preventing concerns about film formation defects caused by an inability to conform to the shape of the substrate, which occurs when a gas separating layer with a small pore diameter is formed as a thin film by overlaying it on the substrate with a large pore diameter.

Then, since the resulting gas separation membrane is composed of the first gas separating layer 12 and the second gas separating layer 13, which have a gas separating function, and the first gas separating layer 12 is impregnated and formed within the thickness range of the substrate 11, it is possible to reduce the thickness of the entire gas separation membrane, thereby increasing gas permeability, while achieving high gas separability through the two gas separating layers, the first gas separating layer 12 and the second gas separating layer 13.

In addition, in the first membrane forming liquid application process S2 or the second membrane forming liquid application process S4, for example, when the spray application is used, during application, the droplets of each membrane forming liquid become smaller and the membrane thickness can be made thinner, so the drying time in the drying process of each post-process can be shortened and the gas separation membrane 10 can be produced efficiently.

Hereinabove, while the embodiments of the present invention have been described, these embodiments are presented as examples and are not intended to limit the scope of the invention. Such embodiments can be implemented in various other forms, and various omissions, substitutions, and modifications can be made without departing from the scope of the invention. These embodiments and variations thereof are intended to be included in the scope of the invention as defined in the claims and their equivalents, as well as within the scope and scope of the invention.

According to the gas separation membrane and the method of manufacturing a gas separation membrane of the present invention, carbon dioxide (CO₂) can be recovered highly efficiently and at low cost from low-concentration emission sources with a carbon dioxide concentration of 10% or less. Accordingly, this contributes to realization of a carbon neutral society. Accordingly, industrial applicability is provided.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A gas separation membrane comprising:
a porous substrate;
a first gas separating layer impregnated and formed onto one surface of the porous substrate; and
a second gas separating layer disposed so as to overlap the first gas separating layer,
wherein the first gas separating layer has higher gas permeability and lower gas selectivity than the second gas separating layer.

2. The gas separation membrane according to claim 1, wherein an average pore diameter of the first gas separating layer is smaller than an average pore diameter of the porous substrate, and equal to or smaller than a thickness of the second gas separating layer.

3. A method of manufacturing a gas separation membrane for manufacturing the gas separation membrane according to claim 1, the method comprising:
a first membrane forming liquid application process of applying a first membrane forming liquid in which composition materials of the first gas separating layer are dissolved or distributed in a first solvent onto one surface of the porous substrate, impregnating the first membrane forming liquid to a predetermined depth from the one surface of the porous substrate, and forming the first gas separating layer impregnated onto the one surface side of the porous substrate; and
a second membrane forming liquid application process of applying a second membrane forming liquid in which composition materials of the second gas separating layer are dissolved or distributed in a second solvent so as to overlap the first gas separating layer impregnated onto the one surface side of the porous substrate by the first membrane forming liquid application process and forming the second gas separating layer.

4. The method of manufacturing a gas separation membrane according to claim 3, wherein the first solvent is poorly soluble or insoluble in the second solvent.

5. The method of manufacturing a gas separation membrane according to claim 3, wherein the first solvent is a non-polar solvent and the second solvent is a polar solvent.

6. The method of manufacturing a gas separation membrane according to claim 3, wherein the composition materials of the first gas separating layer are rubber-like polymer materials, and the composition materials of the second gas separating layer are glass-like polymer materials.

7. The method of manufacturing a gas separation membrane according to claim 3, wherein application of the first membrane forming liquid application process and the second membrane forming liquid application process is spray application.
